(19) United States
(12) Patent Application Publication
(10) Pub. No.: US 2024/0279251 A1
(43) Pub. Date: Aug. 22, 2024

(54) Monomer, Polymerizable Composition, and Polymers Derived Therefrom

(71) Applicant: 3M INNOVATIVE PROPERTIES COMPANY, St. Paul, MN (US)

(72) Inventors: Claire Hartmann-Thompson, Lake Elmo, MN (US); Erik M. Townsend, South St. Paul, MN (US); Binhong Lin, Woodbury, MN (US); Phillip D. Hustad, St. Paul, MN (US)

(21) Appl. No.: 18/290,334

(22) PCT Filed: Mar. 30, 2022
(86) PCT No.: PCT/IB2022/052954

§ 371 Date: Nov. 13, 2023

Related U.S. Application Data
(60) Provisional application No. 63/188,680, filed on May 14, 2021.

(51) Int. Cl. C07F 7/08; C08G 61/08

(52) U.S. Cl. CPC C07F 7/0805; C08G 61/08; C08G 2261/144; C08G 2261/3324; C08G 2261/418

(57) ABSTRACT

A monomer represented by the formula: (I) wherein: each R¹ independently represents an alkyl group having from 1 to 4 carbon atoms; Z represents an alkyl group having 1 to 40 carbon atoms, or a group represented by the formula (II) wherein: each L independently represents a divalent alkylene group having 1 to 12 carbon atoms, each n independently represents 0, 1, or 2; and p represents 0 or 1. A polymerizable composition includes the monomer and can be polymerized to form a polymerized composition. Polymers prepared by polymerization of the monomer are also disclosed.

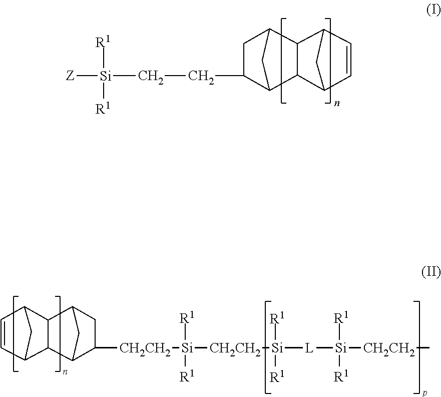

### TECHNICAL FIELD

The present disclosure broadly relates to silicon carbosilane monomers, polymerizable compositions including them, and polymers derived from them.

### BACKGROUND

Fifth-generation wireless (5G) is the latest iteration of cellular technology, engineered to greatly increase the speed and responsiveness of wireless networks. With 5G, data transmitted over wireless broadband connections can travel at multigigabit speeds, with potential peak speeds as high as 20 gigabits per second (Gbps) by some estimates. The increased speed is achieved partly by using higher frequency radio waves than current cellular networks. However, higher frequency radio waves have a shorter range than the frequencies used by previous networks. So to ensure wide service, 5G networks operate on up to three frequency bands, low, medium, and high. A 5G network will be composed of networks of up to 3 different types of cell, each requiring different antennas, each type giving a different tradeoff of download speed vs. distance and service area. 5G cellphones and wireless devices will connect to the network through the highest speed antenna within range at their location.

Low-band 5G uses a similar frequency range as current 4G cellphones, 600-700 MHz giving download speeds a little higher than 4G: 30-250 megabits per second (Mbit/s). Low-band cell towers will have a similar range and coverage area to current 4G towers. Mid-band 5G uses microwaves of 2.5-3.7 GHz, currently allowing speeds of 100-900 Mbit/s, with each cell tower providing service up to several miles radius. High-band 5G uses frequencies of 25-39 GHz, near the bottom of the millimeter wave band, to achieve download speeds of 1-3 gigabits per second (Gbit/s), comparable to cable internet.

Progression of communications technology toward 5G is putting increased properties demands on materials for electronic applications. Examples include: dielectric constant Dk<3.0, dissipation factor Df<0.003 at 30 GHz, low thermal expansion (CTE: <50 microns/(m·° C.), and good thermo-oxidative stability (<5 weight percent loss at ˜>50° C. above the glass transition temperature (T_{g}) and/or melt transition temperature (Tₘ).

Many materials used in the telecommunication industry today do not perform well at 5G frequencies. Thus, the higher frequencies of 5G necessitate the identification and development of materials that can function at those frequencies and not interfere with proper functioning of electronic devices communicating at high-band wavelengths.

### SUMMARY

Polyolefin thermosets offer a desirable combination of minimized signal loss at 5G/6G, toughness, hydrolysis resistance, high service temp (T_{g} up to 350° C.), low viscosity, and simpler manufacturing (e.g., good adhesion without surface preparation). Low dielectric constants (Dk) and low dissipation factors (Df) suitable for 5G are achieved by chemical structures that have minimal polarizability in response to an oscillating electric field (where Dk is the in-phase response, and Df is the out-of-phase loss response). For polymers, this can be achieved with C—C, C—H, C—F and C—Si bonds, and by avoiding pi-bonding and aromaticity, polar bonds, and heavier atoms. Larger size scale factors (e.g., crystallinity and polymer architecture) also influence Dk and Df. Olefin (C—C and C—H) structures also have excellent hydrolysis and alkali resistance. Structures incorporating norbornene-based cyclic olefins offer a means to improve thermal performance without using aromatic groups that are detrimental to dielectric properties.

The present disclosure provides norbornene-based monomers having silicon-containing pendant groups. The norbornene-based monomers can be polymerized by ring opening metathesis polymerization (ROMP) or addition polymerization (AP) to generate polymers suitable for use in applications requiring low dielectric constant (Dk) and dissipation factor (Df) for 5G/6G, and/or hydrolysis/chemical resistance.

The norbornenyl monomers may have the following combination of benefits: (1) higher molecular mass, lower volatility, and lower odor than norbornene; (2) pendant groups that increase mass without containing heteroatoms that are detrimental to Dk and Df_{f}; (3) low viscosity for ease of formulation into olefin thermosets; and (4) ability to tailor the glass transition temperature of derivative polymers by varying length and type of silicon-containing pendant group, and by using alone, or in combination with commercially available norbornene-based monomers (e.g., norbornene, hexyl- or decyl-norbornene, ethylidene norbornene).

In one aspect, the present disclosure provides a monomer represented by the formula:

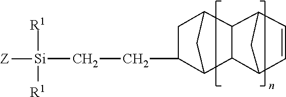

wherein:
each R¹ independently represents an alkyl group having from 1 to 4 carbon atoms;
Z represents an alkyl group having 1 to 40 carbon atoms, or a group represented by the formula

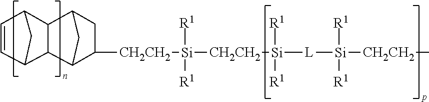

wherein:
   each L independently represents a divalent alkylene group having 1 to 12 carbon atoms,
   each n independently represents 0, 1, or 2; and
   p represents 0 or 1.

Monomers according to the present disclosure are useful, for example, as components of polymerizable compositions.

In another aspect, the present disclosure provides a polymerizable composition comprising a monomer according to the present disclosure and a curative for the monomer.

In yet another aspect, the present disclosure provides a polymerized composition preparable by polymerization of a polymerizable composition according to the present disclosure.

In yet another aspect, the present disclosure provides a A polymer comprising tetravalent or octavalent monomeric units represented by the formula

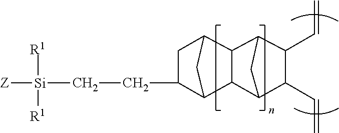

wherein:
each R¹ independently represents an alkyl group having from 1 to 4 carbon atoms;
each n independently represents 0 or 1; and
Z represents an alkyl group having 1 to 40 carbon atoms, or a group represented by the formula

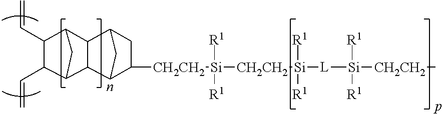

wherein:
   each L independently represents a divalent alkylene group having 1 to 12 carbon atoms,
   p represents 0 or 1.

In yet another aspect, the present disclosure provides a polymer comprising divalent or tetravalent monomeric units represented by the formula

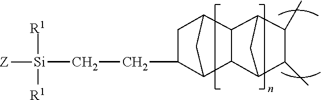

wherein:
each R¹ independently represents an alkyl group having from 1 to 4 carbon atoms;
Z represents an alkyl group having 1 to 40 carbon atoms, or a group represented by the formula

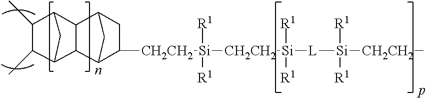

wherein:
   each L independently represents a divalent alkylene group having 1 to 12 carbon atoms,
   each n independently represents 0, 1, or 2; and
   p represents 0 or 1.

As used herein:
the term “carbosilane” refers to a compound composed of carbon, silicon, and hydrogen atoms.

Features and advantages of the present disclosure will be further understood upon consideration of the detailed description as well as the appended claims.

### DETAILED DESCRIPTION

### Monomers

Monomers according to the present disclosure can be represented by the formula

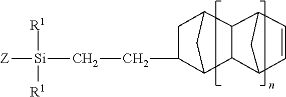

wherein each R¹ independently represents an alkyl group having from 1 to 4 carbon atoms such as, for example, methyl ethyl, propyl, or butyl.

Z may represent an alkyl group having 1 to 40 carbon atoms (preferably 1 to 30 carbon atoms, more preferably 1 to 18 carbon atoms). Examples include methyl, ethyl, propyl, butyl, pentyl, hexyl (including cyclohexyl), heptyl (including methylcyclohexyl), octyl, nonyl, decyl, undecyl, dodecyl, hexadecyl, octadecyl, triacontyl, and tetracontyl.

Alternatively, Z may be represented by the formula

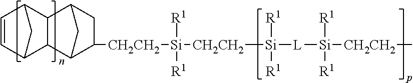

wherein each L independently represents a divalent alkylene group having 1 to 12 carbon atoms (e.g., methyl, ethyl, propyl, butyl, pentyl, hexyl, cyclohexyl, heptyl, octyl, nonyl, decyl, undecyl, or dodecyl).

Each p represents 0 or 1. In many embodiments, p=0.

Each n independently represents 0, 1, or 2. In many embodiments, n=0.

In some preferred embodiments, monomers according to the present disclosure are represented by the formulas:

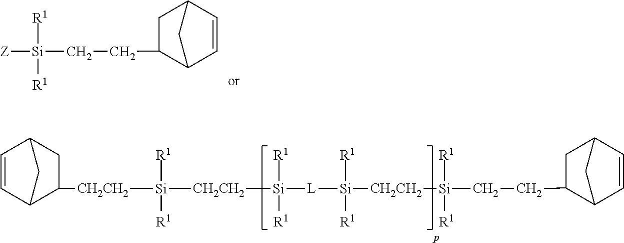

Monomers with n=1 or 2 can be made by conventional synthetic techniques such as, for example, Diels-Alder condensation with cyclopentadiene from their corresponding norbornyl precursors.

Monomers according to the present disclosure can be made, for example, by hydrosilylation of corresponding carbosilanes with alkenes in the presence of a hydrosilylation catalyst, for example, as shown below

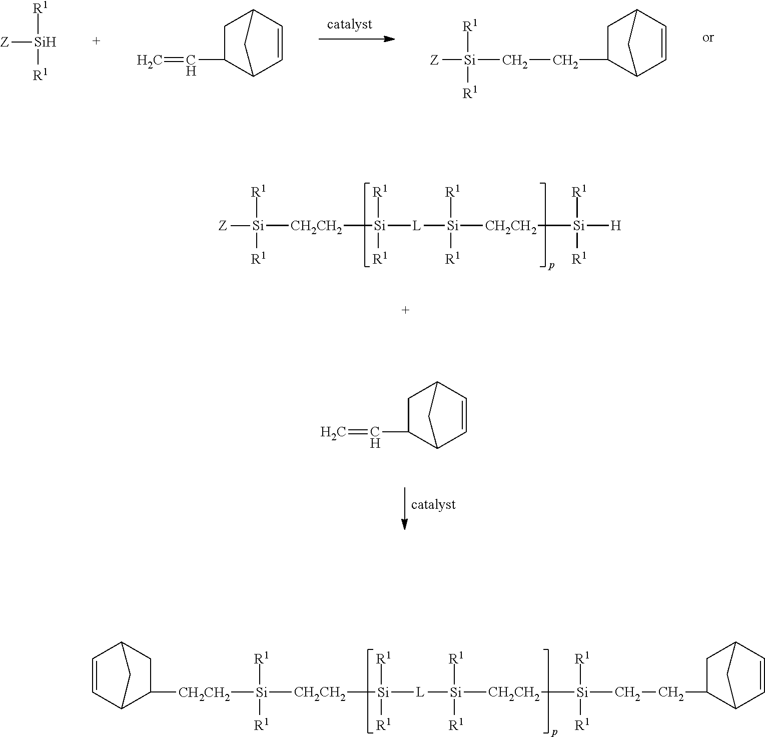

5-Vinyl-2-norbornene is commercially available from many commercial sources. Alternatively, synthetic methods are known in the art. Hydrosilanes represented by the formula

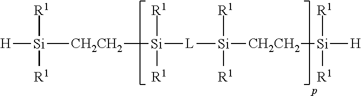

can be obtained from commercials suppliers (e.g., Gelest Inc., Morrisville, Pennsylvania and Millipore-Sigma, Saint Louis, Missouri) or made by known methods (e.g., by hydrosilylation of corresponding dialkyldihydrosilanes with corresponding divinyldialkylsilanes or dienes in the presence of a hydrosilylation catalyst).

Examples of hydrosilylation catalysts include platinum-based catalysts, such as chloroplatinic acid, a solution of chloroplatinic acid in an alcohol, the reaction product of chloroplatinic acid and an alcohol, the reaction product of chloroplatinic acid and an olefin compound, the reaction product of chloroplatinic acid and a vinyl group-containing siloxane, platinum-olefin complexes, platinum-vinyl group-containing siloxane complexes; and platinum group-based catalysts, such as a rhodium complex and a ruthenium complex. One particularly useful catalyst (Karstedt's catalyst) is a platinum-divinyltetramethyldisiloxane complex in vinyl-terminated polydimethylsiloxane (PDMS), containing between 3 weight percent (wt-%) platinum concentration (concentration of pure platinum metal), obtained under the product code SIP6830.3 from Gelest, Morrisville, Pennsylvania. The hydrosilylation catalysts may be used by dissolving or dispersing in a solvent such as isopropanol or toluene, or a silicone oil.

The amount of the hydrosilylation catalyst can be generally about 5 ppm or greater, or about 10 ppm or greater, and about 2,000 ppm or less, or about 500 ppm or less based on 100 parts by weight of the solid content of the silicone pressure-sensitive adhesive, as determined by the weight of platinum group metal.

### Polymerizable Composition

Monomers according to the present disclosure are generally polymerizable and can be included in a polymerizable composition along with a curative for the monomer and optional co-monomers. Optional co-monomers and additives may be included in the polymerizable composition in any amount depending on the desired physical properties in the resultant polymer, for example.

As used herein, the term “curative” refers to any compound or combination of compounds that can cause polymerization or copolymerization of the monomer(s) and optional co-monomer(s). Choice of curative, amounts, and polymerization conditions will necessarily depend at least in part on the type of polymerization chosen (e.g., free-radical polymerization initiator, addition polymerization catalyst, or Ring Opening Metathesis Polymerization (ROMP) catalyst, and is within the capability of those having ordinary skill in the art).

The curative is typically included in at least an effective amount. By the term “effective amount” is meant an amount that is at least sufficient amount to cause polymerization of the polymerizable composition under polymerization conditions. Typically, the total amount of curative is used in amounts ranging from 0.0001 to 20 percent by weight (preferably 0.001 to 5 percent by weight), based on the total weight of the polymerizable composition, although this is not a requirement.

### Free-Radical Polymerization

Suitable free-radical polymerization initiators may include, for example, thermal and/or photoinitiators. Exemplary thermal initiators include organic peroxides (e.g., diacyl peroxides, peroxy ketals, ketone peroxides, hydroperoxides, dialkyl peroxides, peroxy esters, and peroxydicarbonates) and azo compounds (e.g., azobis(isobutyronitrile)). Examples of free-radical photoinitiators include: 2-benzyl-2-(dimethylamino)-4′-morpholinobutyrophenone; 1-hydroxycyclohexyl-phenyl ketone; 2-methyl-1-[4-(methylthio)phenyl]-2-morpholinopropan-1-one; 4-methylbenzophenone; 4-phenylbenzophenone; 2-hydroxy-2-methyl-1-phenylpropanone; 1-[4-(2-hydroxyethoxyl)-phenyl]-2-hydroxy-2-methylpropanone; 2,2-dimethoxy-2-phenylacetophenone; 4-(4-methylphenylthio)benzophenone; benzophenone; 2,4-diethylthioxanthone; 4,4′-bis(diethylamino)benzophenone; 2-isopropylthioxanthone; acylphosphine oxide derivatives, acylphosphinate derivatives, and acylphosphine derivatives (e.g., phenylbis(2,4,6-trimethylbenzoyl)phosphine oxide (available as OMNIRAD 819 from IGM Resins, St. Charles, Illinois), phenylbis(2,4,6-trimethylbenzoyl)phosphine (e.g., as available as OMNIRAD 2100 from IGM Resins), bis(2,4,6-trimethylbenzoyl)phenylphosphine oxide, 2,4,6-trimethylbenzoyldiphenylphosphine oxide (e.g., as available as OMNIRAD 8953X from IGM Resins), isopropoxyphenyl-2,4,6-trimethylbenzoylphosphine oxide, dimethyl pivaloylphosphonate), ethyl (2,4,6-trimethylbenzoyl) phenyl phosphinate (e.g., as available as OMNIRAD TPO-L from IGM Resins); bis(cyclopentadienyl) bis[2,6-difluoro-3-(1-pyrryl)phenyl]titanium (e.g., as available as OMNIRAD 784 from IGM Resins); and combinations thereof.

Exemplary free-radically copolymerizable monomers may include alkenes having one or more carbon-carbon double bonds and having 1 to 18 carbon atoms (e.g., ethylene, propylene, butene, butadiene, isoprene, hexene, cyclohexene, octene, decene, hexadecene, or octadecene). While other free-radically polymerizable monomers may be included, they are preferably free of heteroatoms (e.g., O, N, P, S) other than silicon.

### Addition Polymerization

As used herein, the term “addition polymerization” (also sometimes referred to in the art as vinyl-addition polymerization) refers to a polymerization process involving an olefin coordination-insertion pathway mediated by an organometallic catalyst. A schematic depiction is shown in Scheme I, below.

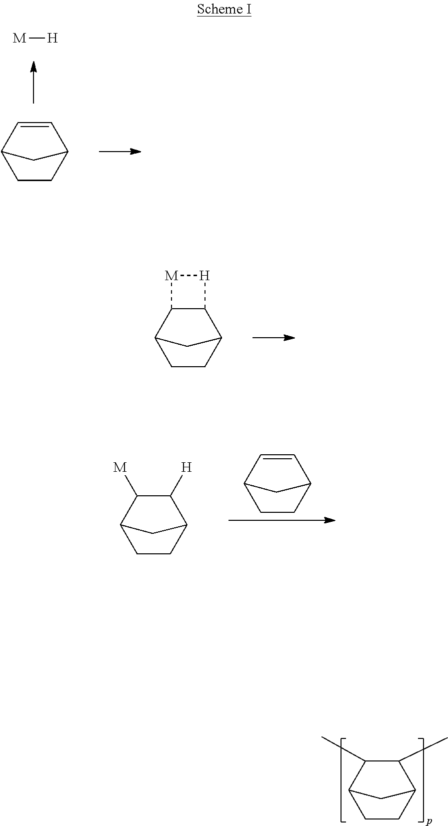

where M-H indicates an addition polymerization catalytic species having a metal hydride bond, and p represents an integer greater than 10. This process is distinguished from a common alternative polymerization method, Ring-opening Metathesis Polymerization (ROMP), both in mechanism and end product. ROMP polymers contain double bonds in the polymer backbone, whereas addition polymers according to the present disclosure do not.

A great many addition polymerization catalysts are known in the art and are typically based on organometallic catalysts comprising Ti, Zr, Cr, Co, Fe, Cu, Ni, or Pd. Of these, addition polymerization catalysts comprising Ni or Pd are most commonly-used. There is voluminous literature on organometallic addition polymerization catalysts, and especially for norbornene-type monomers. Generally, the active catalyst species is a cationic transition metal complex that has an alkyl or allyl ligand and a weakly coordinating anion. The addition polymerization catalyst may be included in curable compositions according to the present disclosure a single active species (or a combination thereof) or it may be provided as a precursor combination of a procatalyst and an activator; for example, as is common in the art. Generally, the procatalyst provides the active site for the olefin insertion mechanism that forms the addition polymer. Combination with the activator converts the procatalyst into its active form.

In some embodiments, appropriate catalyst(s) and procatalyst/activator combinations for the addition polymerization of cycloolefins comprising a ring having a single carbon-carbon bond may include Group 10 (i.e., of the Periodic Table of the Elements) catalyst(s) or procatalyst/activator combinations; for example, Ni-based, Pd-based, or Pt-based addition polymerization catalysts. In some preferred embodiments, late metal (e.g., Ni- or Pd-based) procatalysts have allyl/alkyl ligands as well as chloride ligands. These procatalysts are activated by the addition of monovalent metal (Li, Na, Ag) salts of weakly coordinating anions (e.g., BF₄, tetrakis(3,5-bis(trifluoromethyl)phenyl)borate (BARF), or perfluorotetraphenylborate).

Exemplary suitable procatalysts include: (1,1-dimethylallyl)palladium(triisopropylphosphine) trifluoroacetate, (2-chloroallyl)palladium(triisopropylphosphine) trifluoroacetate, (allyl)palladium-(tricyclohexylphosphine) chloride, (allyl)palladium(tricyclohexylphosphine) p-tolylsulfonate, (allyl)palladium(tricyclohexylphosphine) triflate, (allyl)palladium(tricyclohexylphosphine) triflimide, (allyl)palladium(tricyclohexylphosphine) trifluoroacetate, (allyl)palladium(triisopropylphosphine) triflate, (allyl)palladium(triisopropylphosphine) triflimide, (allyl)palladium(triisopropylphosphine) trifluoroacetate, (allyl)palladium(trinaphthylphosphine) triflate, (allyl)palladium(tri-o-tolylphosphine) acetate, (allyl)palladium(tri-o-tolylphosphine) nitrate, (allyl)palladium(tri-o-tolylphosphine) triflate, (allyl)palladium(triphenylphosphine) triflate, (allyl)palladium(triphenylphosphine) triflimide, (allyl)palladium(tricyclopentylphosphine) triflate, (allyl)palladium(tri-o-tolylphosphine) chloride, (allyl)Pd(AsPh₃)Cl, (allyl)Pd(PPh₃)Cl, (allyl)Pd(PCy₃)C₆F₅, (allyl)Pd(P-i-Pr₃)C₆F₅, (allyl)Pd(PMe₃)OC(O)CH₂CH═CH₂, (allyl)Pd(SbPh₃)Cl, (C₂H₅)Pd(PMe₃)₂Br, (C₂H₅)Pd(PMe₃)₂Br, (C₂H₅)Pd(PMe₃)₂Cl(Ph), (CH₃)Pd(P(i-Pr)₃)₂O₃SCF₃, (CH₃)Pd(PMe₂Ph)₂Cl, (CH₃)Pd(PMe₃)₂Cl, (CH₃)Pd(PMe₃)NO₃, (crotyl)palladium(tricyclohexylphosphine) triflate, (crotyl)palladium(tricyclopentylphosphine) triflate, (crotyl)palladium(triisopropylphosphine) triflate, (cyclooctadiene)palladium(II) dichloride, (hydrido)palladiumbis(tricyclohexylphosphine) chloride, (hydrido)palladiumbis(tricyclohexylphosphine) formate (hydrido)palladiumbis(tricyclohexylphosphine) nitrate, (hydrido)palladiumbis(tricyclohexylphosphine) triflate, (hydrido)palladiumbis(tricyclohexylphosphine) trifluoroacetate, (hydrido)palladiumbis(triisopropylphosphine) chloride, (hydrido)palladiumbis(triisopropylphosphine) triflate, (Me₂NCH₂C₆H₄)Pd(O₃SCF₃)P(cyclohexyl)₃, (methallyl)palladium(tricyclohexylphosphine) acetate, (methallyl)palladium(tricyclohexylphosphine) chloride, (methallyl)palladium(tricyclohexylphosphine) triflate, (methallyl)palladium(tricyclohexylphosphine) triflimide, (methallyl)palladium(tricyclohexylphosphine) trifluoroacetate, (methallyl)-palladium(tricyclopentylphosphine) acetate, (methallyl)palladium(tricyclopentylphosphine) chloride, (methallyl)palladium(tricyclopentylphosphine) triflate, (methallyl)palladium(tricyclopentylphosphine) triflimide, (methallyl)palladium(tricyclopentylphosphine) trifluoroacetate, (methallyl)palladium-(triisopropylphosphine) acetate, (methallyl)palladium(triisopropylphosphine) chloride, (methallyl)-palladium(triisopropylphosphine) triflate, (methallyl)palladium(triisopropylphosphine) triflimide, (methallyl)palladium(triisopropylphosphine) trifluoroacetate, (methallyl)Pd(AsPh₃)Cl, (methallyl)-Pd(P[(OCH₂)₃]CH)Cl, (methallyl)Pd(PBu₃)Cl, (methallyl)Pd(PPh₃)Cl, (methallyl)Pd(SbPh₃)Cl, (Ph)Pd(PMe₃)₂Br, (PMe₃)₂Br, (η¹-benzyl)Pd(PEt₃)₂Cl, [(allyl)Pd(HOCH₃)(P-i-Pr₃)][B(O₂-3,4,5,6-Br₄C₆)₂], [(allyl)Pd(HOCH₃)(P-i-Pr₃)][B(O₂-3,4,5,6-Cl₄C₆)₂], [(allyl)Pd(HOCH₃)(P-i-Pr₃)]—[B(O₂C₆H₄)₂], [(allyl)Pd(OEt₂)(PCy₃)][BF₄], [(allyl)Pd(OEt₂)(PCy₃)][PF₆], [(allyl)Pd(OEt₂)(P-iPr₃)], [(allyl)Pd(OEt₂)(P-i-Pr₃)][BPh₄], [(allyl)Pd(OEt₂)(P-i-Pr₃)][ClO₄], [(allyl)Pd(OEt₂)(PPh₃)][SbF₆], [(allyl)Pd(OEt₂)(P-i-Pr₃)][PF₆], [(allyl)Pd(OEt₂)(PPh₃)][BF₄], [(allyl)Pd(OEt₂)(PPh₃)][PF₆], [(dimethylamino)methyl]phenyl-C,N-}-palladium(tricyclohexylphosphine) triflate, [SbF₆][(allyl)-Pd(OEt₂)(P-i-Pr₃)][BF₄], {2-[(dimethylamino)methyl]phenyl-C,N-}-palladium(tricyclohexylphosphine) chloride, dibromobis(benzonitrile)palladium(II), dichlorobis(acetonato)palladium (II), dichlorobis-(acetonitrile)palladium(II), dichlorobis(benzonitrile)palladium (II), palladium (II) bis(tricyclohexylphosphine) bis(trifluoroacetate), palladium (II) bis(tricyclohexylphosphine) diacetate, palladium (II) bis(tricyclohexylphosphine) dibromide, palladium (II) bis(tricyclohexylphosphine) dichloride, palladium (II) bis(triisopropylphosphine) bis(trifluoroacetate), palladium (II) bis(triisopropylphosphine) diacetate, palladium (II) bis(triisopropylphosphine) dibromide, palladium (II) bis(triisopropylphosphine) dichloride, palladium (II) bis(triphenylphosphine) bis(trifluoroacetate), palladium (II) bis(triphenylphosphine) diacetate, palladium (II) bis(triphenylphosphine) dibromide, palladium (II) bis(triphenylphosphine) dichloride, palladium (II) bis(tri-p-tolylphosphine) bis(trifluoroacetate), palladium (II) bis(tri-p-tolylphosphine) diacetate, palladium (II) bis(tri-p-tolylphosphine) dibromide, palladium (II) bis(tri-p-tolylphosphine) dichloride, palladium (II) ethyl hexanoate, palladium(II) acetylacetonate, palladium(II) bis(trifluoroacetate), palladium(II) ethylhexanoate, Pd(acetate)₂(PPh₃)₂, Pd(PMe₃)₂Cl, (CH₃)Pd, PdBr₂(P(p-tolyl)₃)₂, PdBr₂(PPh₃)₂, PdCl₂(P(cyclohexyl)₃)₂, PdCl₂(P(o-tolyl)₃)₂, PdCl₂(PPh₃)₂; platinum (II) chloride; platinum (II) bromide, platinum bis(triphenylphosphine)dichloride, trans-PdCl₂(PPh₃)₂, (methallyl)nickel(tricyclohexylphosphine) triflate, nickel acetylacetonate, nickel carboxylates, nickel (II) chloride, nickel(II) bromide, nickel ethylhexanoate, nickel (II) trifluoroacetate, nickel (II) hexafluoroacetylacetonate, NiCl₂(PPh₃)₂, NiBr₂P(p-tolyl)₃)₂, (allyl)platinum(tricyclohexylphosphine) chloride, (allyl)platinum(tricyclohexylphosphine) triflate, allylchloro[1,3-bis(2,6-di-i-propylphenyl)-4,5-dihydroimidazol-2-ylidene]palladium(II), allylchloro[1,3-bis(2,6-di-i-propylphenyl)imidazol-2-ylidene]palladium(II), chloro[(1,2,3-η)-3-phenyl-2-propenyl][1,3-bis(2,6-di-i-propylphenyl)-4,5-dihydroimidazol-2-ylidene]palladium (II), chloro[(1,2,3-η)-3-phenyl-2-propenyl][1,3-bis(2,6-di-i-propylphenyl)imidazol-2-ylidene]palladium (II), allylchloro[1,3-bis(2,6-di-i-propylphenyl)-4,5-dihydroimidazol-2-ylidene]nickel (II), allylchloro[1,3-bis(2,6-di-i-propylphenyl)imidazol-2-ylidene]nickel(II), chloro[(1,2,3-η)-3-phenyl-2-propenyl][1,3-bis(2,6-di-i-propylphenyl)-4,5-dihydroimidazol-2-ylidene]nickel (II), and chloro[(1,2,3-η)-3-phenyl-2-propenyl][1,3-bis(2,6-di-i-propylphenyl)imidazol-2-ylidene]nickel (II).

Addition of a Lewis base, which coordinately bonds to the metal atom, may improve the activity of addition polymerization catalysts and/or procatalysts. That is, the Lewis base is bonded to the metal atom by sharing both of its lone pair of electrons. Any Lewis base known in the art can be used for this purpose. Preferably, the Lewis base can dissociate readily under the polymerization conditions.

Exemplary suitable Lewis bases include substituted and unsubstituted nitriles, including alkyl nitrile, aryl nitrile or aralkyl nitrile; phosphine oxides, including substituted and unsubstituted trialkylphosphine oxides, triarylphosphine oxides, triaralkylphosphine oxides, and various combinations of alkyl, aryl and aralkylphosphine oxides; substituted and unsubstituted pyrazines; substituted and unsubstituted pyridines; phosphites, including substituted and unsubstituted trialkyl phosphites, triaryl phosphites, triaralkyl phosphites, and various combinations of alkyl, aryl and aralkyl phosphites; phosphines, including substituted and unsubstituted trialkylphosphines, triarylphosphines, triaralkylphosphines, and various combinations of alkyl, aryl, and aralkyl phosphines. Various other Lewis bases that may be used include various ethers, alcohols, ketones, amines and anilines, arsines, and stibines. In some embodiments, the Lewis base can be selected from acetonitrile, propionitrile, n-butyronitrile, tert-butyronitrile, benzonitrile (C₆H₅CN), 2,4,6-trimethylbenzonitrile, phenyl acetonitrile (C₆H₅CH₂CN), pyridine, 2-methylpyridine, 3-methylpyridine, 4-methylpyridine, 2,3-dimethylpyridine, 2,4-dimethylpyridine, 2,5-dimethylpyridine, 2,6-dimethylpyridine, 3,4-dimethylpyridine, 3,5-dimethylpyridine, 2,6-di-t-butylpyridine, 2,4-di-t-butylpyridine, 2-methoxypyridine, 3-methoxypyridine, 4-methoxypyridine, pyrazine, 2,3,5,6-tetramethylpyrazine, diethyl ether, di-n-butyl ether, dibenzyl ether, tetrahydrofuran, tetrahydropyran, benzophenone, triphenylphosphine oxide, triphenyl phosphate and PR¹₃, wherein each R is independently selected from methyl, ethyl, (C₃-C₆) alkyl, substituted or unsubstituted (C₃-C₇) cycloalkyl, (C₆-C₁₀) aryl, (C₆-C₁₀) aralkyl, methoxy, ethoxy, (C₃-C₆) alkoxy, substituted or unsubstituted (C₃-C₇) cycloalkoxy, (C₆-C₁₀) aryloxy and (C₆-C₁₀) aralkyloxy.

Representative examples of PR¹₃ include trimethylphosphine, triethylphosphine, tri-n-propylphosphine, triisopropylphosphine, tri-n-butylphosphine, triisobutylphosphine, tri-tert-butylphosphine, tricyclopentylphosphine, triallylphosphine, tricyclohexylphosphine, triphenylphosphine, trimethyl phosphite, triethyl phosphite, tri-n-propyl phosphite, triisopropyl phosphite, tri-n-butyl phosphite, triisobutyl phosphite, tri-tert-butyl phosphite, tricyclopentyl phosphite, triallyl phosphite, tricyclohexyl phosphite, and triphenyl phosphite.

Other examples of organophosphorus compounds suitable as Lewis bases include phosphinite and phosphonite ligands. Representative examples of phosphinite ligands include methyl diphenylphosphinite, ethyl diphenylphosphinite, isopropyl diphenylphosphinite, and phenyl diphenylphosphinite. Representative examples of phosphonite ligands include diphenyl phenylphosphonite, dimethyl phenylphosphonite, diethyl methylphosphonite, diisopropyl phenylphosphonite, and diethyl phenylphosphonite.

If added, the Lewis base may typically be added in a stoichiometric excess amount, although this is not a requirement.

Exemplary activators include: lithium tetrakis(2-fluorophenyl)borate, sodium tetrakis(2-fluorophenyl)borate, silver tetrakis(2-fluorophenyl)borate, thallium tetrakis(2-fluorophenyl)borate, lithium tetrakis(3-fluorophenyl)borate, sodium tetrakis(3-fluorophenyl)borate, silver tetrakis(3-fluorophenyl)borate, thallium tetrakis(3-fluorophenyl)borate, ferrocenium tetrakis(3-fluorophenyl)borate, ferrocenium tetrakis(pentafluorophenyl)borate, lithium tetrakis(4-fluorophenyl)borate, sodium tetrakis(4-fluorophenyl)borate, silver tetrakis(4-fluorophenyl)borate, thallium tetrakis(4-fluorophenyl)borate, lithium tetrakis(3,5-difluorophenyl)borate, sodium tetrakis(3,5-difluorophenyl)borate, thallium tetrakis(3,5-difluorophenyl)borate, trityl tetrakis(3,5-difluorophenyl)borate, 2,6-dimethylanilinium tetrakis(3,5-difluorophenyl)borate, lithium tetrakis(pentafluorophenyl)borate, lithium (diethyl ether)tetrakis(pentafluorophenyl)borate, lithium (diethyl ether)tetrakis(pentafluorophenyl) borate, lithium tetrakis(2,3,4,5-tetrafluorophenyl)borate, lithium tetrakis(3,4,5,6-tetrafluorophenyl)borate, lithium tetrakis(1,2,2-trifluoroethylenyl)borate, lithium tetrakis(3,4,5-trifluorophenyl)borate, lithium methyltris(perfluorophenyl)borate, lithium phenyltris(perfluorophenyl)borate, lithium tris(isopropanol)tetrakis(pentafluorophenyl)borate, lithium tetrakis(methanol)tetrakis(pentafluorophenyl)-borate, silver tetrakis(pentafluorophenyl)borate, tris(toluene)silver tetrakis(pentafluorophenyl)borate, tris(xylene)silver tetrakis(pentafluorophenyl)borate, trityl tetrakis(pentafluorophenyl)borate, trityl tetrakis(4-triisopropylsilyltetrafluorophenyl)borate, trityl tetrakis(4-dimethyl-tert-butylsilyl-tetrafluorophenyl)borate, thallium tetrakis[3,5-bis(trifluoromethyl)phenyl]borate, 2,6-dimethylanilinium tetrakis(pentafluorophenyl)borate, N,N-dimethylanilinium tetrakis(pentafluorophenyl)borate, N,N-dimethylanilinium tetrakis[3,5-bis(trifluoromethyl)phenyl]borate, lithium (triphenylsiloxy)-tris(pentafluorophenyl)borate, sodium (triphenylsiloxy)tris(pentafluorophenyl)borate, sodium tetrakis(2,3,4,5-tetrafluorophenyl)borate, sodium tetrakis(3,4,5,6-tetrafluorophenyl)borate, sodium tetrakis(1,2,2-trifluoroethylenyl)borate, sodium tetrakis(3,4,5-trifluorophenyl)borate, sodium methyltris(perfluorophenyl)borate, sodium phenyltris(perfluorophenyl)borate, thallium tetrakis(2,3,4,5-tetrafluorophenyl)borate, thallium tetrakis(3,4,5,6-tetrafluorophenyl)borate, thallium tetrakis(1,2,2-trifluoroethylenyl)borate, thallium tetrakis(3,4,5-trifluorophenyl)borate, sodium methyltris(perfluoro-phenyl)borate, thallium phenyltris(perfluorophenyl)borate, trityl tetrakis(2,3,4,5-tetrafluorophenyl)borate, trityl tetrakis(3,4,5,6-tetrafluorophenyl)borate, trityl tetrakis(1,2,2-trifluoroethylenyl)borate, trityl tetrakis(3,4,5-trifluorophenyl)borate, trityl methyltris(pentafluorophenyl)borate, trityl phenyltris(perfluoro-phenyl)borate, silver tetrakis[3,5-bis(trifluoromethyl)phenyl]borate, silver(toluene) tetrakis[3,5-bis(trifluoromethyl)phenyl]borate, thallium tetrakis[3,5-bis(trifluoromethyl)phenyl]borate, lithium hexyltris(pentafluorophenyl)borate, lithium triphenylsiloxytris(pentafluorophenyl)borate, lithium (octyloxy)tris(pentafluorophenyl)borate, lithium tetrakis(3,5-bis(trifluoromethyl)phenyl)borate, sodium tetrakis(pentafluorophenyl)borate, trityl tetrakis(pentafluorophenyl)borate, sodium (octyloxy)tris(penta-fluorophenyl)borate, sodium tetrakis(3,5-bis(trifluoromethyl)phenyl)borate, potassium tetrakis(pentafluoro-phenyl)borate, trityl tetrakis(pentafluorophenyl)borate, potassium (octyloxy)tris(pentafluorophenyl)borate, potassium tetrakis(3,5-bis(trifluoromethyl)phenyl)borate, magnesium tetrakis(pentafluorophenyl)borate, magnesium (octyloxy)tris(pentafluorophenyl)borate, magnesium tetrakis(3,5-bis(trifluoro-methyl)phenyl)borate, calcium tetrakis(pentafluorophenyl)borate, calcium (octyloxy)tris(pentafluoro-phenyl)borate, calcium tetrakis(3,5-bis(trifluoromethyl)phenyl)borate, lithium tetrakis[3,5-bis[1-methoxy-2,2,2-trifluoro-1-trifluoromethyl)ethyl]phenyl]borate, sodium tetrakis[3,5-bis[1-methoxy-2,2,2-trifluoro-1-(trifluoromethyl)ethyl]phenyl]borate, silver tetrakis[3,5-bis[1-methoxy-2,2,2-trifluoro-1-(trifluoromethyl)-ethyl]phenyl]borate, thallium tetrakis[3,5-bis[1-methoxy-2,2,2-trifluoro-1-(trifluoromethyl)-ethyl]phenyl]borate, lithium tetrakis[3-[1-methoxy-2,2,2-trifluoro-1-(trifluoromethyl)ethyl]-5-(trifluoro-methyl)phenyl]borate, sodiumtetrakis[3-[1-methoxy-2,2,2-trifluoro-1-(trifluoromethyl)ethyl]-5-(trifluoromethyl)phenyl]borate, silver tetrakis[3-[1-methoxy-2,2,2-trifluoro-1-(trifluoromethyl)ethyl]-5-(trifluoromethyl)phenyl]borate, thallium tetrakis[3-[1-methoxy-2,2,2-trifluoro-1-(trifluoromethyl)ethyl]-5-(trifluoromethyl)phenyl]borate, lithium tetrakis[3-[2,2,2-trifluoro-1-(2,2,2-trifluoroethoxy)-1-(trifluoromethyl)ethyl]-5-(trifluoromethyl)phenyl]borate, sodium tetrakis[3-[2,2,2-trifluoro-1-(2,2,2-trifluoroethoxy)-1-(trifluoromethyl)ethyl]-5-(trifluoromethyl)phenyl]borate, silver tetrakis [3-[2,2,2-trifluoro-1-(2,2,2-trifluoroethoxy)-1-(trifluoromethyl)ethyl]-5-(trifluoromethyl)phenyl]borate, thallium tetrakis[3-[2,2,2-trifluoro-1-(2,2,2-trifluoroethoxy)-1-(trifluoromethyl)ethyl]-5-(trifluoromethyl)-phenyl]borate, trimethylsilylium tetrakis(pentafluorophenyl)borate, trimethylsilylium etherate tetrakis-(pentafluorophenyl)borate, triethylsilylium tetrakis(pentafluorophenyl)borate, triphenylsilylium tetrakis(pentafluorophenyl)borate, tris(mesityl)silylium tetrakis(pentafluorophenyl)borate, tribenzylsilylium tetrakis(pentafluorophenyl)borate, trimethylsilylium methyltris(pentafluorophenyl)borate, triethylsilylium methyltris(pentafluorophenyl)borate, triphenylsilylium methyltris(pentafluorophenyl)borate, tribenzylsilylium methyltris(pentafluorophenyl)borate, trimethylsilylium tetrakis(2,3,4,5-tetrafluorophenyl)borate, triethylsilylium tetrakis(2,3,4,5-tetrafluorophenyl)borate, triphenylsilylium tetrakis(2,3,4,5-tetrafluorophenyl)borate, tribenzylsilylium tetrakis(2,3,4,5-tetrafluorophenyl)borate, trimethylsilylium tetrakis(2,3,4,5-tetrafluorophenyl) borate, triphenylsilylium tetrakis(2,3,4,5-tetra-fluorophenyl)borate, trimethylsilylium tetrakis(3,4,5-trifluorophenyl)borate, tribenzylsilylium tetrakis(3,4,5-trifluorophenyl)aluminate, triphenylsilylium methyltris(3,4,5-trifluorophenyl) aluminate, triethylsilylium tetrakis(1,2,2-trifluoroethenyl)borate, tricyclohexylsilylium tetrakis(2,3,4,5-tetrafluorophenyl)borate, dimethyloctadecylsilylium tetrakis(pentafluorophenyl)borate, tris(trimethylsilyl)-silylium methyltris(2,3,4,5-tetrafluorophenyl)borate, 2,2′-dimethyl-1,1′-binaphthylmethylsilylium tetrakis(pentafluorophenyl)borate, 2,2′-dimethyl-1,1′-binaphthylmethylsilylium tetrakis(3,5-bis(trifluoromethyl)phenyl)borate, lithium tetrakis(pentafluorophenyl)aluminate, trityl tetrakis(pentafluorophenyl)aluminate, trityl (perfluorobiphenyl)fluoroaluminate, lithium (octyloxy)-tris(pentafluorophenyl)aluminate, lithium tetrakis(3,5-bis(trifluoromethyl)phenyl)aluminate, sodium tetrakis(pentafluorophenyl)aluminate, trityl tetrakis(pentafluorophenyl)aluminate, sodium (octyloxy)-tris(pentafluorophenyl)aluminate, sodium tetrakis(3,5-bis(trifluoromethyl)phenyl)aluminate, potassium tetrakis(pentafluorophenyl)aluminate, trityl tetrakis(pentafluorophenyl)aluminate, potassium (octyloxy)-tris(pentafluorophenyl)aluminate, potassium tetrakis(3,5-bis(trifluoromethyl)phenyl)aluminate, magnesium tetrakis(pentafluorophenyl)aluminate, magnesium (octyloxy)tris(pentafluorophenyl)aluminate, magnesium tetrakis(3,5-bis(trifluoromethyl)phenyl)aluminate, calcium tetrakis(pentafluorophenyl)aluminate, calcium (octyloxy)tris(pentafluorophenyl)aluminate, calcium tetrakis(3,5-bis(trifluoromethyl)phenyl)aluminate, LiB(OC(CF₃)₃)₄, LiB(OC(CF₃)₂(CH₃))₄, LiB(OC(CF₃)₂H)₄, LiB(OC(CF₃)(CH₃)H)₄, Tl(OC(CF₃)₃)₄, TlB(OC(CF₃)₂H)₄, TlB(OC(CF₃)(CH₃)H)₄, TlB(OC(CF₃)₂(CH₃))₄, (Ph₃C)B(OC(CF₃)₃)₄, (Ph₃C)B(OC(CF₃)₂(CH₃))₄, (Ph₃C)B(OC(CF₃)₂H)₄, (Ph₃C)B(OC(CF₃)(CH₃)H)₄, AgB(OC(CF₃))₄, AgB(OC(CF₃)₂H)₄, AgB(OC(CF₃)(CH₃)H)₄, LiB(O₂C₆F₄)₂, TlB(O₂C₆F₄)₂, Ag(toluene)₂B(O₂C₆F₄)₂, Ph₃CB(O₂C₆F₄)₂ LiB(OCH(CF₃)₂)₄, [Li(HOCH₃)₄]B(O₂C₆Cl₄)₂, [Li(HOCH₃)₄]B(O₂C₆F₄)₂, [Ag(toluene)₂]B(O₂C₆Cl₄)₂, LiB(O₂C₆Cl₄)₂, (LiAl(OC(CF₃)₂Ph)₄), (TlAl(OC(CF₃)₂Ph)₄), (AgAl(OC(CF₃)₂Ph)₄), (Ph₃CAl(OC(CF₃)₂Ph)₄, (LiAl(OC(CF₃)₂C₆H₄CH₃)₄), (TlAl(OC(CF₃)₂C₆H₄CH₃)₄), (AgAl(OC(CF₃)₂C₆H₄CH₃)₄), (Ph₃CAl(OC(CF₃)₂C₆H₄CH₃)₄), LiAl(OC(CF₃))₄, TlAl(OC(CF₃)₃)₄, AgAl(OC(CF₃)₃)₄, Ph₃CAl(OC(CF₃)₃)₄, LiAl(OC(CF₃)(CH₃)H)₄, TlAl(OC(CF₃)(CH₃)H)₄, AgAl(OC(CF₃)(CH₃)H)₄, Ph₃CAl(OC(CF₃)(CH₃)H)₄, LiAl(OC(CF₃)₂H)₄, TlAl(OC(CF₃)₂H)₄, AgAl(OC(CF₃)₂H)₄, Ph₃CAl(OC(CF₃)₂H)₄, LiAl(OC(CF₃)₂C₆H₄-4-i-Pr)₄, TlAl(OC(CF₃)₂C₆H₄-4-i-Pr)₄, AgAl(OC(CF₃)₂C₆H₄-i-Pr)₄, Ph₃CAl(OC(CF₃)₂C₆H₄₋₄-i-Pr)₄, LiAl(OC(CF₃)₂C₆H₄-t-butyl)₄, TlAl(OC(CF₃)₂C₆H₄-t-butyl)₄, AgAl(OC(CF₃)₂C₆H₄₋₄-t-butyl)₄, LiAl(OC(CF₃)₂C₆H₄-4-SiMe₃)₄, TlAl(OC(CF₃)₂C₆H₄-4-SiMe₃)₄, AgAl(OC(CF₃)₂C₆H₄-4-SiMe₃)₄, Ph₃CAl(OC(CF₃)₂C₆H₄-4-SiMe₃)₄, LiAl(OC(CF₃)₂C₆H₄-4-Si-i-Pr₃)₄, TlAl(OC(CF₃)₂C₆H₄-4-Si-i- Pr₃)₄, AgAl(OC(CF₃)₂C₆H₄-4-Si-i-Pr₃)₄, Ph₃CAl(OC(CF₃)₂C₆H₄-4-Si-i-Pr₃)₄, LiAl(OC(CF₃)₂C₆H₂-2,6-(CF₃)₂-4-Si-i-Pr₃)₄, TlAl(OC(CF₃)₂C₆H₂-2,6-(CF₃)₂-4-Si-i-Pr₃)₄, AgAl(OC(CF₃)₂C₆H₂-2,6-(CF₃)₂-4-Si-i-Pr₃)₄, Ph₃CAl(OC(CF₃)₂C₆H₂-2,6-(CF₃)₂-4-Si-i-Pr₃)₄, LiAl(OC(CF₃)₂C₆H₃-3,5-(CF₃)₂)₄, TlAl(OC(CF₃)₂C₆H₃-3,5-(CF₃)₂)₄, AgAl(OC(CF₃)₂C₆H₃-3,5-(CF₃)₂)₄, Ph₃CAl(OC(CF₃)₂C₆H₃-3,5-(CF₃)₂)₄, LiAl(OC(CF₃)₂C₆H₂-2,4,6-(CF₃))₄, TlAl(OC(CF₃)₂C₆H₂-2,4,6-(CF₃)₃)₄, AgAl(OC(CF₃)₂C₆H₂-2,4,6-(CF₃)₃)₄, Ph₃CAl(OC(CF₃)₂C₆H₂-2,4,6-(CF₃L)₄, LiAl(OC(CF₃)₂C₆F₅)₄, TlAl(OC(CF₃)₂C₆F₅)₄, AgAl(OC(CF₃)₂C₆F₅)₄, Ph₃CAl(OC(CF₃)₂C₆F₅)₄, [1,4-dihydro-4-methyl-1-(pentafluorophenyl)]-2-borinyl lithium, [1,4-dihydro-4-methyl-1-(pentafluorophenyl)]-2-borinyl triphenylmethylium, 4-(1,1-dimethyl)-1,2-dihydro-1-(pentafluorophenyl)-2-borinyllithium, 4-(1,1-dimethyl)-1,2-dihydro-1-(pentafluorophenyl)-2-borinyltriphenylmethylium, 1-fluoro-1,2-dihydro-4-(pentafluorophenyl)-2-borinyllithium, 1-fluoro-1,2-dihydro-4-pentafluorophenyl)-2-borinyl triphenylmethylium, 1-[3,5-bis(trifluoromethyl)phenyl]-1,2-dihydro-4-(pentafluorophenyl)-2-borinyl lithium, and 1-[3,5-bis(trifluoromethyl)phenyl]-1,2-dihydro-4-(pentafluorophenyl)-2-borinyl triphenylmethylium.

Typically, the molar ratio of activator to procatalyst is in the range of 10:1 to 1:10, preferably 10:1 to 1:1, although other ratios may also be used.

In order to control molecular weight, it may be desirable to include an alkene such as for example, 1-octene. 1-hexene, 1-pentene, 1-decene, or 1-dodocene.

Many useful addition polymerization catalysts and procatalyst/activator combinations are known and are disclosed, for example, in col. 8, line 28 to col. 9 line 56 of U.S. Pat. No. 3,330,815 (McKeon et al.); col. 3, line 9 to col. 17, line 16 of U.S. Pat. No. 6,455,650 B1 (Lipian et al.); col. 3, line 18 to col. 31, line 53 of U.S. Pat. No. 6,825,307 (Goodall); col. 3, line 31 to col. 17, line 16 of U.S. Pat. No. 6,903,171 B2 (Rhodes et al.); and col. 16, line 32 to col. 28, line 31 of U.S. Pat. No. 7,759,439 B2 (Rhodes et al.); col. 20, line 28 to col. 21, line 30 in U.S. Pat. No. 10,266,720 (Burgoon et al.); and paragraphs [0015] to [0075] of U. S. Pat. Appl. Publ. 2005/0187398 A1 (Bell et al.), the disclosures of which are incorporated herein by reference. Another category of catalysts involves procatalyst complexes of early or late metals that do not initially have alkyl/allyl ligands but are alkylated by a cocatalyst such as, for example, methylaluminoxane. In some embodiments, organometallic addition polymerization catalysts comprise palladium or nickel.

Details concerning certain addition polymerization catalysts are also reported by M. V. Bermeshev and P. P. Chapala in “Addition polymerization of functionalized norbornenes as a powerful tool for assembling molecular moieties of new polymers with versatile properties”, Progress in Polymer Science (2018), 84, pp. 1-46.

### ROMP Polymerization

ROMP is a well known process that converts cyclic olefins into polymer using a ROMP catalyst. Ring-opening metathesis polymerization of cycloalkene monomers typically yields crosslinked polymers having an unsaturated linear backbone. The degree of unsaturation of the repeat backbone unit of the polymer is the same as that of the monomer. For example, with a norbornene reactant in the presence of an appropriate catalyst, the resulting polymer may be represented by:

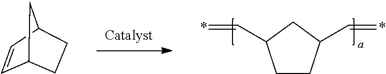

wherein a is the number of repeating monomer units in the polymer chain.

For another example, with dienes such as dicyclopentadiene in the presence of an appropriate catalyst, the resulting polymer may be represented by:

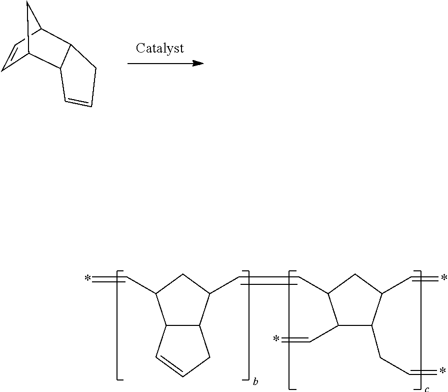

wherein b+c is the number of moles of polymerized monomer, and c/(b+c) is the mole fraction of monomer units which ring-open at both reactive sites and * indicates continued polymeric structure. As shown by the above reaction, metathesis polymerization of dienes, trienes, etc. can result in a crosslinked polymer. Representative cycloalkene monomers, catalysts, procedures, etc. that can be used in metathesis polymerizations are described, for example, in: U.S. Pat. No. 4,400,340 (Klosiewicz); U.S. Pat. No. 4,751,337 (Espy et al.); U.S. Pat. No. 5,849,851 (Grubbs et al.); and U.S. Pat. No. 6,800,170 B2 (Kendall et al.); and U.S. Pat. Appl. Publ. No. 2007/0037940 A1 (Lazzari et al.).

Exemplary useful ROMP catalysts include dichloro[1,3-bis(2,4,6-trimethylphenyl)-2-imidazolidinylidene](benzylidene)bis(3-bromopyridine)ruthenium(II) (Grubbs catalyst C884); (1,3-Bis-(2,4,6-trimethylphenyl)-2-imidazolidinylidene)dichloro(o-isopropoxyphenylmethylene)ruthenium, Dichloro[1,3-bis(2,4,6-trimethylphenyl)-2-imidazolidinylidene](2-isopropoxyphenylmethylene)ruthenium(II) (Hoveyda-Grubbs catalyst C627); (1,3-Bis(2,4,6-trimethylphenyl)-2-imidazolidinylidene)dichloro(phenylmethylene)(tricyclohexylphosphine)ruthenium Grubb Catalyst C 848), benzylidene-bis(tricyclohexylphosphine)dichlororuthenium (Grubbs Catalyst C823), dichloro(tricyclohexylphosphine)[(tricyclohexylphosphoranyl)methylidene]ruthenium(II) tetrafluoroborate (Grubbs Catalyst C833); dichloro[1,3-bis(2-methylphenyl)-2-imidazolidinylidene](benzylidene)(tricyclohexylphosphine)ruthenium(II) (Grubbs Catalyst C793), all of which are available from MilliporeSigma (Sigma-Aldrich, Saint Louis, Missouri), and ROMP catalyst Prod. No. 1250BP from Materia Inc., Pasadena, California.

In some embodiments, ROMP catalysts comprise at least one of ruthenium, tungsten, osmium, or molybdenum.

### Optional Co-Monomers and Additives

Monomers according to the present disclosure can be polymerized, optionally with other co-monomers.

Examples of suitable co-polymerizable monomers include norbornene, 1-methylnorbornene, 5-methylnorbornene, 7-methylnorbornene, 5-(2-ethylhexyl)norbornene, 1-pentadecylnorbornene, 5,5-dimethylnorbornene, 5,5-dibutylnorbornene, 5,7-dibutylnorbornene, 5-methyl-5-ethylnorbornene, 5,6-didodecylnorbornene, 5-ethyl-6-propylnorbornene, 5,5,6,6-tetramethylnorbornene, 1-phenylnorbornene, 5-naphthylnorbornene, 5,5-diphenylnorbornene, 5-vinylnorbornene, 7-vinylnorbornene, 5-propenyl-6-methylnorbornene, 5-tolylnorbornene, 5-benzylnorbornene, 5-cyclopentylnorbornene, 1,5,5-trimethylnorbornene, 5-isopropenylnorbornene, 1-isopropylnorbornene, 1-ethylnorbornene, 1,5-dimethylnorbornene, 1,5-diethylnorbornene, 1,6-dimethylnorbornene, 5,5,6-trimethylnorbornene, 5-cyclopropylnorbornene, 5-cyclohexylnorbornene, 5-cyclopentenylnorbornene, 5-(2′-norbornyl)norbornene, 5-phenylnorbornene, 5-benzylnorborn-2-ene, 5-(2′-phenylethyl)norbornene, 5-(3′-phenylpropyl)norbornene, 5-(4′-phenylbutyl)norbornene, 2,5-norbornadiene, cyclohexene, cyclopentene, dicyclopentadiene, 2,5-norbornadiene, bicyclo[2.2.2]-2-octene, indene, 5-methylenenorbornene, 5-ethylidenenorbornene, 5-propylidenenorbornene, 5-hexylidenenorbornene, 5-decylidenenorbornene, 5-methylene-6-methylnorbornene, 5-methylene-6-hexylnorbornene, 5-cyclohexylidenenorbornene, 5-cyclooctylidenenorbornene, 7-isopropylidenenorbornene, 5-methyl-7-isopropylidenenorbornene, 5-hydroxymethyl-6-methylenenorbornene, 7-ethylidenenorbornene, 5-methyl-7-propylidenenorbornene,

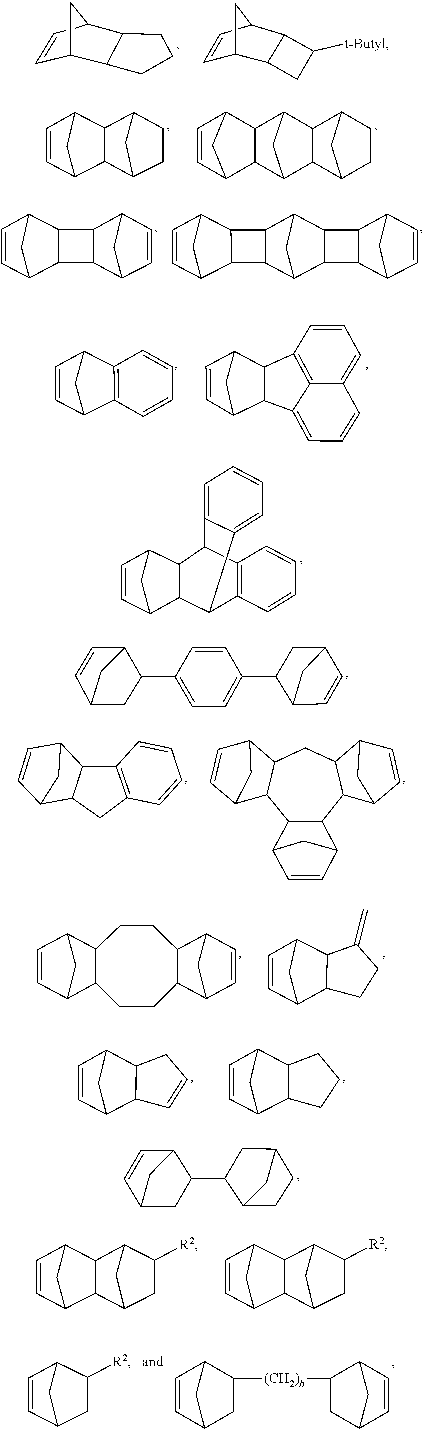

wherein R² represents an alkyl group having from 1 to ten carbon atoms (e.g., methyl, ethyl, propyl, butyl, pentyl, hexyl, heptyl, octyl, nonyl, decyl), and n represents an integer from 1 to 10 (e.g., 1, 2, 3, 4, 5, 6, 8, 10).

Especially in cases of catalyzed addition polymerization and ring-opening metathesis polymerization, suitable optional co-monomers may include at least one cyclic olefin (e.g., norbornene or a substituted derivative thereof). Examples include compounds represented by the formulas

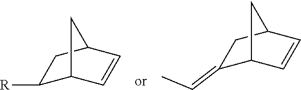

including stereoisomers thereof, wherein R represents H or an alkyl group having up to ten carbon atoms. Examples of R include hydrogen, methyl, ethyl, propyl, butyl, pentyl, hexyl, cyclohexyl, heptyl, octyl, nonyl, and decyl.

Co-monomers with multiple alicyclic rings containing double bonds can be used to form crosslinked polymerized compositions, for example.

Polymerizable compositions may optionally include other components such as, for example, fillers (e.g., thermal fillers and/or electrically-conductive fillers), thixotropes, plasticizers, colorants, fragrances, antioxidants, ultraviolet (UV) light stabilizers, and/or tackifiers.

### Polymers

In some preferred embodiments, polymerizable compositions according to the present disclosure, when polymerized, can both form linear and crosslinked polymers (including homopolymers and copolymers).

One exemplary polymer comprises tetravalent or octavalent monomeric units represented by the formula

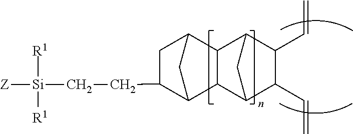

wherein:
each R¹ independently represents an alkyl group having from 1 to 4 carbon atoms;
each n independently represents 0 or 1; and
Z represents an alkyl group having 1 to 40 carbon atoms, or a group represented by the formula

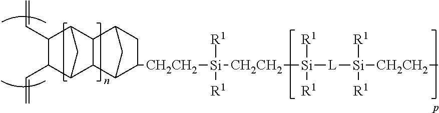

wherein:
   each L independently represents a divalent alkylene group having 1 to 12 carbon atoms, and
   p represents 0 or 1.

Another exemplary polymer comprises divalent or tetravalent monomeric units represented by the formula

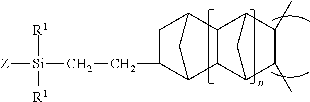

wherein R¹, n, and p are as previously defined, and Z is a tetravalent segment represented by
each R¹ independently represents an alkyl group having from 1 to 4 carbon atoms;
Z represents an alkyl group having 1 to 40 carbon atoms, or a group represented by the formula

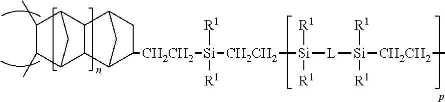

wherein:
   each L independently represents a divalent alkylene group having 1 to 12 carbon atoms, and
   p represents 0 or 1.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

TABLE 1, below, reports materials used in the examples and their sources.

TABLE 1

| MATERIAL | SOURCE |
|---|---|
| 5-Vinylbicyclo[2.2.1]hept-2-ene | TCI America, Portland, Oregon |
| (i.e., 5-Viny1-2-norbornene) | |
| Ethyldimethylsilane | Millipore-Sigma, Saint Louis, Missouri |
| n-Butyldimethylsilane | Gelest Inc., Morrisville, Pennsylvania |
| n-Octadecyldimethylsilane | Gelest Inc. |
| 1,1,4,4-Tetramethy1-1,4-disilabutane | Gelest Inc. |
| 1,7-Octadiene | Millipore-Sigma |
| Tetrakis(dimethylsiloxy)silane | Gelest Inc. |
| Platinum divinyltetramethyldisiloxane | Gelest Inc. |
| complex | |
| (3 weight percent in vinyl-terminated | |
| PDMS) | |
| Allyl[1,3-bis(2,6- | Strem Chemicals, Newburyport, |
| diisopropylphenyl)imidazol-2- | Massachusetts |
| ylidene]chloropalladium(II): | |
| “IDippPd(allyl)Cl” | |
| Sodium tetrakis[3,5- | Alfa Aesar, Ward Hill, Massachusetts |
| bis(trifluoromethyl)phenyl]borate: | |
| “Na(BARF)” | |
| Tricyclohexylphosphine: “PCy₃” | Alfa Aesar |
| 1,2-dichloroethane “DCE” | Alfa Aesar |
| ROMP Catalyst 1 | Prod. No. 1250BP, Materia Inc., |
| | Pasadena, California |
| ROMP Catalyst 2 | Prod. No. CT762, Materia Inc. |

### Characterization Methods

### Characterization by ¹H NMR

NMR samples were analyzed as solutions in deuterated chloroform. ¹NMR spectroscopy was conducted using a Bruker AVANCE III 500 MHz NMR spectrometer equipped with a CPBBO gradient cryoprobe, a Bruker B-ACS 60 autosampler, and Bruker Topspin 3.04 software. Spectra were analyzed using Advanced Chemistry Development software (Toronto, Canada).

### Characterization by GPC

Solutions of approximate concentration 1.5 mg/mL were prepared in toluene. The samples were swirled on an orbital shaker for 12 hrs. The sample solutions were filtered through 0.45-micron PTFE syringe filters and then analyzed by GPC. An Agilent (Santa Clara, California) 1260 LC instrument was used with a Jordi DVB+Jordi 500 Å (50 nm) column set at 40° C., toluene eluent (+2% triethylamine) at 1.0 m/min, a NIST polystyrene standard (SRM 705a), and an Agilent 1260 Evaporative Light Scattering Detector.

### Characterization by GCMS

Samples were diluted in toluene and injected directly into an Agilent 7890A GC-MS instrument (Rxi-1ms, 30 m×0.25 mm, 0.25 micron film column) with EI mass spectrometry 70 eV Scan 29-650 Da detection.

### Cylindrical Dielectric Resonator Measurements for Liquids at 2.45 GHz

A TE_{01δ} mode cylindrical dielectric resonator was adapted to measure the complex permittivity of dielectrics at a frequency 2.45 GHz using the method described in J. Krupka, K. Derzakowski, M. D. Janezic, and J. Baker-Jarvis, “TE01delta dielectric resonator technique for precise measurements of the complex permittivity of lossy liquids at frequencies below 1 GHz”, Conference on Precision Electromagnetic Measurements Digest, pp. 469-470, London, 27 Jun.-2 Jul. 2004.

### Example 1

### Preparation of Monomer 1

Ethyldimethylsilane (5.00 g, 56.7 mmol) was added dropwise to a solution of 5-vinylbicyclo-[2.2.1]hept-2-ene (6.81 g, 56.7 mmol) and platinum divinyltetramethyldisiloxane complex (1 drop) in toluene (30 mL) that had been cooled to 0° C. in an ice bath. The reaction mixture was left to warm up to room temperature and stirred for 3 days, and toluene and excess reagents were removed in vacuo to give the product as a transparent colorless liquid. 1H NMR (CDCl₃) showed 94% yield (silicon positions carrying norbornene groups); m/z (EI) 179 (M-Et), 121 (Norbornene-CH₂CH₂), 87 (Si(CH₃)₂Et).

### Example 2

### Preparation of Monomer 2

n-Butyldimethylsilane (12.46 g, 10.7 mmol) was added dropwise to a solution of 5-vinylbicyclo 2.2.1 hept-2-ene (12.88 g, 10.7 mmol) and platinum divinyltetramethyldisiloxane complex (1 drop) in toluene (100 mL) that had been cooled to 0° C. in an ice bath. The reaction mixture was left to warm up to room temperature and stirred for 2 days, and toluene and excess reagents were removed in vacuo to give the product as a transparent colorless liquid. 1H NMR (CDCl₃) showed 98% yield (silicon positions carrying norbornene groups); m/z (EI) 179 (M-Bu), 121 (Norbornene-CH₂CH₂), 115 (Si(CH₃)₂Bu) 59 (Bu).

### Example 3

### Preparation of Monomer 3

n-Octyldimethylsilane (10.59 g, 33.9 mmol) was added dropwise to a solution of 5-vinylbicyclo 2.2.1 hept-2-ene (4.07 g, 33.9 mmol) and platinum divinyltetramethyldisiloxane complex (1 drop) in toluene (50 mL). The reaction mixture was stirred for 4 days at room temperature ° C., and toluene and excess reagents were removed in vacuo to give the product as a transparent colorless oil. 1H NMR (CDCl₃) showed 95% yield (silicon positions carrying norbornene groups).

### Example 4

### Preparation of Crosslinker 4

1,1,4,4-Tetramethyl-1,4-disilabutane (9.83 g, 67.0 mmol) was added dropwise to a solution of 5-vinylbicyclo 2.2.1 hept-2-ene (16.15 g, 0.134 mol) and platinum divinyltetramethyldisiloxane complex (1 drop) in toluene (100 mL). After an initial 1exotherm, the reaction mixture was stirred for 2 days at room temperature, and toluene and excess reagents were removed in vacuo to give the product as a transparent colorless oil. ¹H NMR (CDCl₃) showed 70% yield (silicon positions carrying norbornene groups); m/z (EI) 387 (M+), 179 (Norbornenene-CH₂CH₂Si(CH₃)₂).

### Example 5

### Preparation of Crosslinker 5

1,1,4,4-Tetramethyl-1,4-disilabutane (10.12 g, 69.1 mmol) was added dropwise to a solution of 1,7-octadiene (3.81 g, 34.6 mmol) and platinum divinyltetramethyldisiloxane complex (1 drop) in toluene (80 mL). After an initial exotherm, the reaction mixture was stirred for 30 mins at room temperature. 5-Vinylbicyclo[2.2.1]hept-2-ene (8.31 g, 61.9 mmol) was added and the reaction mixture was stirred for 6 days at 50° C., and toluene and excess reagents were removed in vacuo to give the product as a transparent pale yellow oil. ¹H NMR (CDCl₃) showed 74% yield (silicon positions carrying norbornene groups). A molecular mass in the target range was demonstrated by GPC (toluene, ELSD): Mₙ=1300 g/mol, M_{w}=1500 g/mol, polydispersity 1.1.

### Example 6

### Preparation of Crosslinker 6

Tetrakis(dimethylsiloxy)silane (7.50 g, 22.8 mmol) was added dropwise to a solution of 5-vinylbicyclo 2.2.1 hept-2-ene (10.97 g, 91.3 mmol) and platinum divinyltetramethyldisiloxane complex (1 drop) in toluene (100 mL). The initial exotherm was managed by alternately applying and removing a room temperature water bath over 30 mins. The reaction mixture was stirred at 50° C. for 6 days, and toluene and excess reagents were removed in vacuo to give the product as a transparent pale yellow oil. 1H NMR (CDCl₃) showed 50% yield (silicon positions carrying norbornene groups). A molecular mass in the target range was demonstrated by GPC (toluene, ELSD): Mₙ=1100 g/mol, M_{w}=1400 g/mol, polydispersity 1.3.

Table 2, below, reports dielectric constants and dissipation factors of unreacted liquid monomers and crosslinkers at 2.45 GHz.

TABLE 2

2.45 GHz

| | DIELECTRIC | DISSIPATION |
|---|---|---|
| MATERIAL | CONSTANT | FACTOR TANδ |
| Monomer 1 | 2.31 | 0.012 |
| Monomer 2 | 2.29 | 0.013 |
| Monomer 3 | 2.23 | 0.008 |
| Crosslinker 4 | 2.40 | 0.007 |
| Crosslinker 5 | 2.36 | 0.011 |
| Crosslinker 6 | 2.49 | 0.014 |

### Characterization of Films by DMA

Storage and loss modulus were measured on an AresG2 Dynamic Mechanical Analyzer (DMA, Model Q800 V21.3 Build 96) using a multi-frequency-strain module. Film samples were cut to size and mounted in the tension film clamp. The furnace was equilibrated at 30° C. and then ramped at 5° C./min to 300° C. while applying an oscillating strain of 0.1% at static force of 0.02 N.

### Addition Polymerization (AP)

### Palladium Catalyst Solution

A solution was prepared by dissolving allylchloro[1,3-bis(2,6-di-i-propylphenyl)-4,5-dihydroimidazol-2-ylidene]palladium(II) (12 mg, 21 micromoles), tricyclohexylphosphine (11.8 mg, 42 micromoles, 2.0 equiv), and sodium tetrakis[3,5-bis(trifluoromethyl)phenyl]borate (91.3 mg, 103 micromoles, 4.9 equiv) in 1,2-dichloroethane (24.6 g) by stirring at room temperature for 30 minutes. Several batches of this palladium catalyst solution (with different total masses) were made for use in the below examples, but they always contained the same weight ratios of materials as described in the above procedure.

### Example 7

### Addition Polymerization of Monomer 1

Monomer 1 (4.0 g) was mixed with catalyst solution (6.0 g) and toluene (30.0 g), and stirred for 7 days at room temperature, where viscosity was observed to increase. The product was isolated by precipitation in methanol and drying for 4 hours at 90° C. A white fibrous solid was obtained. 1H NMR (CDCl₃) showed that 100% of norbornene groups had been consumed. A 10 weight percent solution of the product was prepared in toluene, the solution was cast, and a film was obtained drying at room temperature for 12 hrs and 70° C. for 2 hrs. DMA revealed a storage modulus of ˜700 MPa at 30° C. and a flat response in tan delta up to 300° C., indicating T_{g}>300° C.

### Example 8

### Addition Polymerization of Monomer 2

Monomer 1 (4.0 g) was mixed with catalyst solution (5.3 g) and toluene (30.7 g), and stirred for 3 days at room temperature, where viscosity was observed to increase. The product was isolated by precipitation in methanol and drying for 4 hours at 90° C. A white fibrous solid was obtained. ¹H NMR (CDCl₃) showed that 98% of norbornene groups had been consumed. A 10 weight percent solution of the product was prepared in toluene, the solution was cast, and a film was obtained drying at room temperature for 12 hrs and 70° C. for 2 hrs. DMA revealed a storage modulus of ˜150 MPa at 30° C. and T_{g}˜ 290° C. from the tan delta peak.

### Example 9

### Addition Polymerization of Crosslinker 5

Crosslinker 6 (4.0 g) was mixed with catalyst solution (3.9 g) and toluene (32.1 g), and stirred for 7 days at room temperature, where no change in viscosity was observed. A viscous yellow oil was obtained after evaporation of toluene. Crosslinking was demonstrated by the formation of gel fragments in toluene. The soluble component in CDCl₃ was characterized by ¹H NMR, showing that 18% of norbornene groups had reacted.

### Example 10

### Addition Polymerization of Crosslinker 6

Crosslinker 6 (4.0 g) was mixed with catalyst solution (6.2 g) and toluene (29.8 g), and stirred for 7 days at room temperature, where viscosity was observed to increase. The product was isolated by precipitation in methanol and drying for 4 hours at 90° C. A soft tacky solid was obtained. Crosslinking was demonstrated by the formation of a transparent gel with toluene. The soluble component in CDCl₃ was characterized by ¹H, showing that 16% of norbornene groups had reacted.

### Example 11

### Addition Polymerization of Crosslinker 4 (High Temperature)

Crosslinker 4 (1.0 g) was mixed with catalyst solution (0.1 g) and toluene (0.4 g) and stirred for 7 days at room temperature, where viscosity was observed to increase. The mixture was cured at 90° C. for 10 mins, followed by 130° C. for 30 mins to yield a clear gel.

### Comparative Example A

### Addition Polymerization of Decyl-norbornene (Comparative Example)

Pd catalyst solution (0.2 mL, 0.86 mM Pd in dichloroethane) was added to a solution of decyl-norbornene (1.0 g) in toluene (6 mL), and the mixture was stirred at room temperature for 4 hrs. The resulting viscous solution was precipitated in methanol (100 mL), and the white solid was isolated by filtration and dried at 90° C. to constant mass (0.94 g). The solid was fully soluble in toluene, indicating a lack of crosslinking.

### Example 12

### Addition Polymerization of Crosslinker 4 (Room Temperature)

Catalyst solution (0.10 mL, 0.86 mM Pd in dichloroethane) was added to a solution of crosslinker 4 (0.33 g) in toluene (3.3 mL), and the mixture was stirred at room temperature for 4 hrs. The resulting viscous solution was precipitated in methanol (20 mL), and a white solid was isolated by filtration and dried at 90° C. to constant mass (0.18 g). The product was insoluble in toluene, indicating crosslinking in the polymer.

### Example 13

### Addition Copolymerization of Decyl-Norbornene and Crosslinker 4

Pd catalyst solution (0.2 mL, 0.86 mM Pd in dichloroethane) was added to a solution of decyl-norbornene (1.0 g) and crosslinker 4 (0.33 g) in toluene (6 mL), and the mixture was stirred at room temperature for 4 hrs. The resulting viscous solution was precipitated in methanol (100 mL), and the white solid was isolated by filtration and dried at 90° C. to constant mass (0.56 g). The solid was not soluble in toluene, indicating crosslinking in the polymer.

### Ring Opening Metathesis Polymerization (ROMP)

### General Procedure for Ring Opening Metathesis Polymerization (ROMP)

For crosslinker 4 only, 1 g of crosslinker 4 was first dissolved in 0.4 g toluene. The ROMP catalysts (20 mg for crosslinker 4, crosslinker 5, crosslinker 6; 200 mg for monomer 1, monomer 2, monomer 3) were added to the 1 g monomer or crosslinker. The solution was heated at 120° C. for 20 mins.

Results are reported in Table 3, below, ROMP results, wherein a solid non-flowing product indicated successful polymerization.

TABLE 3

| | | ROMP | ROMP |
|---|---|---|---|
| EXAMPLE | MATERIAL | CATALYST 1 | CATALYST 2 |
| 14 | Monomer 1 | solid | solid |
| 15 | Monomer 2 | solid | solid |
| 16 | Monomer 3 | NA | solid |
| 17 | Crosslinker 4 | solid | solid |
| 18 | Crosslinker 5 | solid | solid |
| 19 | Crosslinker 6 | solid | solid |

Any cited references, patents, and patent applications in this application that are incorporated by reference, are incorporated in a consistent manner. In the event of inconsistencies or contradictions between portions of the incorporated references and this application, the information in this application shall control.

The preceding description, given in order to enable one of ordinary skill in the art to practice the claimed disclosure, is not to be construed as limiting the scope of the disclosure, which is defined by the claims and all equivalents thereto.

1. A monomer represented by the formula: 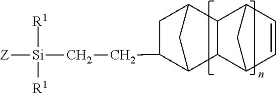
wherein:
each R¹ independently represents an alkyl group having from 1 to 4 carbon atoms;
Z represents an alkyl group having 1 to 40 carbon atoms, or a group represented by the formula 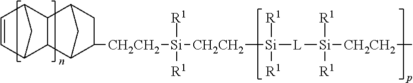
wherein:
each L independently represents a divalent alkylene group having 1 to 12 carbon atoms,
each n independently represents 0, 1, or 2; and
p represents 0 or 1.

2. The monomer of claim 1, wherein Z represents ethyl.

3. The monomer of claim 1, wherein at least one n is 0.

4. The monomer of claim 1, wherein p is 0.

5. The monomer of claim 1, wherein p is 1.

6. A polymerizable composition comprising the monomer of claim 1 and a curative for the monomer.

7. The polymerizable composition of claim 6, wherein the curative for the monomer comprises an organometallic addition polymerization catalyst.

8. The polymerizable composition of claim 7, wherein the organometallic addition polymerization catalyst comprises palladium or nickel.

9. The polymerizable composition of claim 6, wherein the curative comprises a ring opening metathesis polymerization catalyst.

10. The polymerizable composition of claim 9, wherein the ring opening metathesis polymerization catalyst comprises at least one of ruthenium, tungsten, osmium, or molybdenum.

11. The polymerizable composition of claim 1, further comprising at least one cyclic olefin.

12. The polymerizable composition of claim 11, wherein the at least one cyclic olefin is represented by at least one of the formulas 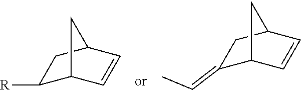
or a stereoisomer thereof, wherein R represents H or an alkyl group having up to ten carbon atoms.

13. A polymerized composition preparable by polymerization of the polymerizable composition of claim 6.

14. A polymer comprising tetravalent or octavalent monomeric units represented by the formula 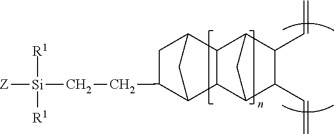
wherein:
each R¹ independently represents an alkyl group having from 1 to 4 carbon atoms;
each n independently represents 0 or 1; and
Z represents an alkyl group having 1 to 40 carbon atoms, or a group represented by the formula 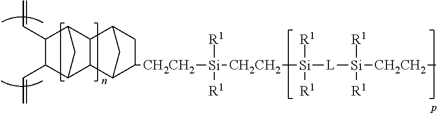
wherein:
each L independently represents a divalent alkylene group having 1 to 12 carbon atoms,
p represents 0 or 1.

15. The polymer of claim 14, wherein each n is 0.

16. A polymer comprising divalent or tetravalent monomeric units represented by the formula 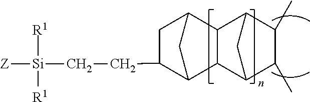
wherein:
each R¹ independently represents an alkyl group having from 1 to 4 carbon atoms;
Z represents an alkyl group having 1 to 40 carbon atoms, or a group represented by the formula 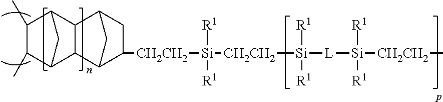
wherein:
each L independently represents a divalent alkylene group having 1 to 12 carbon atoms,
each n independently represents 0, 1, or 2; and
p represents 0 or 1.

17. The polymer of claim 16, wherein each n is 0.
